(19) United States
(12) Patent Application Publication
(10) Pub. No.: US 2023/0054663 A1
(43) Pub. Date: Feb. 23, 2023

(54) COMPUTER-BASED SYSTEMS CONFIGURED FOR RECORD ANNOTATION AND METHODS OF USE THEREOF

(71) Applicant: Capital One Services, LLC, McLean, VA (US)

(72) Inventors: Angelina Wu, Vienna, VA (US); Lin Ni Lisa Cheng, New York, NY (US)

(21) Appl. No.: 17/409,330

(22) Filed: Aug. 23, 2021

(51) Int. Cl. G06N 20/00; G06F 16/2457

(52) U.S. Cl. CPC G06N 20/00; G06F 16/24573

(57) ABSTRACT

Systems and methods of record annotation via machine learning techniques are disclosed. In one embodiment, an exemplary computer-implemented method may comprise: receiving at least one annotating content item being associated with at least one first record of a user; utilizing a trained machine learning model to: i) generate at least one derived annotating content item based at least in part on the at least one annotating content item and data of the at least one first record; ii) identify at least one second record related to the user based at least in part on: the data of the at least one first record and one or both of profile information and context information of the user; and iii) annotate the at least one second record with the at least one derived annotating content item.

### CROSS REFERENCE TO OTHER APPLICATIONS

The present application is a continuation-in-part of U.S. patent application Ser. No. 16/918,618, filed Jul. 1, 2020 and entitled “RECOMMENDATION ENGINE FOR BILL SPLITTING,” and U.S. patent application Ser. No. 16/918,603, filed Jul. 1, 2020 and entitled “PARTICIPANT IDENTIFICATION FOR BILL SPLITTING,” the contents of both of which are incorporated by reference in entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in drawings that form a part of this document: Copyright, Capital One Services, LLC., All Rights Reserved.

### FIELD OF TECHNOLOGY

The present disclosure generally relates to improved computer-implemented methods, improved computer-based platforms or systems, improved computing components and devices configured for one or more novel technological applications involving record annotation via machine learning techniques.

### BACKGROUND OF TECHNOLOGY

A computer network platform/system may include a group of computers (e.g., clients, servers, computing clusters, cloud resources, etc.) and other computing hardware devices that are linked and communicate via software architecture, communication applications, and/or software applications associated with electronic transactions, data processing, and/or service management involved with payment transactions, content curation, record curation, and/or associated record annotation based on processing, implemented in a variety of ways.

### SUMMARY OF DESCRIBED SUBJECT MATTER

In some embodiments, the present disclosure provides various exemplary technically improved computer-implemented methods involving record annotation, the method comprising steps such as: training, by one or more processors, a record annotation machine learning model to obtain a trained record annotation machine learning model that is trained to associate at least one annotating content item with at least one record, wherein the training is based at least in part on: i) training annotating content items from a first plurality of users; ii) a plurality of training records from the first plurality of users, the plurality of training records associated with the training annotating content items; and iii) one or both of profile information and contextual information of the first plurality of users; receiving, by the one or more processors, at least one annotating content item being associated with at least one first record of at least one user of a second plurality of users; utilizing, by the one or more processors, the trained record annotation machine learning model to: generate at least one derived annotating content item based at least in part on the at least one annotating content item and data of the at least one first record, identify at least one second record related to the at least one user of the second plurality of users based at least in part on: the data of the at least one first record and one or both of profile information and context information of the at least one user of the second plurality of users, and annotate the at least one second record with the at least one derived annotating content item.

In some embodiments, the present disclosure also provides exemplary technically improved computer-based systems, and computer-readable media, including computer-readable media implemented with and/or involving one or more software applications, whether resident on personal transacting devices, computer devices or platforms, provided for download via a server and/or executed in connection with at least one network and/or connection, that include or involve features, functionality, computing components and/or steps consistent with those set forth herein.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 is a block diagram of an exemplary system and/or platform illustrating aspects of record annotation, consistent with exemplary aspects of certain embodiments of the present disclosure.

FIG. 2 is a diagram illustrating an exemplary architecture involving aspects and features associated with record annotation, consistent with exemplary aspects of certain embodiments of the present disclosure.

FIG. 3 is a diagram illustrating an exemplary graphical user interface (GUI) involving aspects and features associated with record annotation, in accordance with certain embodiments of the present disclosure.

FIG. 4 is a flowchart illustrating an exemplary process related to record annotation, consistent with exemplary aspects of certain embodiments of the present disclosure.

FIG. 5 is a block diagram depicting an exemplary computer-based system and/or platform, in accordance with certain embodiments of the present disclosure.

FIG. 6 is a block diagram depicting another exemplary computer-based system and/or platform, in accordance with certain embodiments of the present disclosure.

FIGS. 7 and 8 are diagrams illustrating two exemplary implementations of cloud computing architecture/aspects with respect to which the disclosed technology may be specifically configured to operate, in accordance with certain embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

To benefit from the diversity of and intelligence gleaned from various content and at the same time to leverage advanced data processing capabilities, various embodiments of the present disclosure provide for improved computer-based platforms or systems, improved computing components and devices configured for one or more novel technological applications involving obtaining annotating content, generating derived annotating content to annotate records of users, as well as generating intelligence (e.g., machine learning models, etc.) empowered by the various annotating content, annotated records, and/or user profile information and user contextual information to, for example, automate the annotation process with enhanced efficiency, accuracy, relevancy, and accessibility.

As used herein, in some embodiments, the term “record” refers to a content item that is generated to represent information pertaining to an interaction between entities. Entities may include individuals, companies, organizations, federal agencies, state/city/county agencies, and the like. By way of non-limiting example, a record may describe a payment transaction performed between a consumer and a merchant (e.g., credit card transactions, etc.), a collection of information related to an event involving an entity (e.g., a mortgage record, a deed, a zoning permit, a certification, etc.), an action involving an entity, and so on.

As used here, in some embodiments, the terms “annotating content,” “annotating content item,” “annotating data” refer to a content item that can be associated with a record described above. In some embodiments, an annotating content item may be generated by computing devices of entities described above, and/or crawled/acquired from various websites, social media sites, search engines, databases as well. In some embodiments, annotating content may also include any data extracted or otherwise derived from the original content. In some embodiments, a record itself may serve as annotating content with regard to another record. By way of non-limiting example, annotating content may include textual data, image(s), video(s), sound recording(s), chat history, social media post(s), search result(s), email(s), SMS, voice message(s), symbol(s), QR code(s), and the like.

Various embodiments disclosed herein may be implemented in connection with one or more entities that provide, maintain, manage, and/or otherwise offer any services relating to payment transaction system(s). In some embodiments, the exemplary entity may be a financial service entity that provides, maintains, manages, and/or otherwise offers financial services. Such financial service entity may be a bank, credit card issuer, or any other type of financial service entity that generates, provides, manages, and/or maintains financial service accounts that entail providing a transaction card to one or more customers, the transaction card configured for use at a transacting terminal to access an associated financial service account. In some embodiments, financial service accounts may include, for example, credit card accounts, bank accounts such as checking and/or savings accounts, reward or loyalty program accounts, debit account, and/or any other type of financial service account known to those skilled in the art.

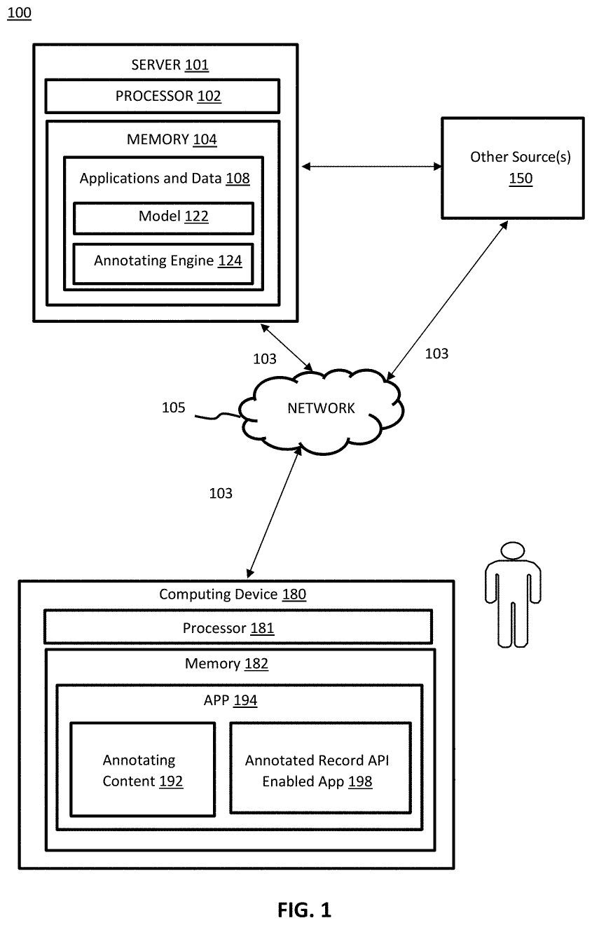

FIG. 1 depicts an exemplary computer-based system 100 illustrating aspects of improved record annotation via utilization of at least one machine learning technique, in accordance with one or more embodiments of the present disclosure. An exemplary system 100 may include at least one server 101, and at least one computing device 180 associated with a user, which may communicate 103 over at least one communication network 105. In some embodiments and in optional combination with one or more embodiments described herein, the system 100 may further include and/or be operatively connected and/or be in electronic communication with one or more other electronic sources 150, from which the server 101 and/or the computing device 180 of the user may access, search, retrieve, and/or otherwise curate records, information pertinent to records, annotating data, user profile data, user contextual data, and/or any other suitable data for record annotation.

In some embodiments, server 101 may include one or more general purpose computers, servers, mainframe computers, desktop computers, etc. configured to execute instructions to perform server and/or client-based operations that are consistent with one or more aspects of the present disclosure. In some embodiments, server 101 may include a single server, a cluster of servers, or one or more servers located in local and/or remote locations. Server 101 may be standalone, or it may be part of a subsystem, which may, in turn, be part of a larger computer system. In some embodiments, server 101 may be associated with a financial institution, such as a credit card company that has issued a transaction card to the user, and thereby having access to transactions performed by various users.

Still referring to FIG. 1, server 101 may include at least one processor 102, and a memory 104, such as random-access memory (RAM). In some embodiments, memory 104 may store applications and data 108. Various embodiments herein may be configured such that the applications and data 108, when executed by the processor 102, may provide all or portions of the features and functionality associated with record annotation via machine learning techniques, in conjunction with or independent of the features and functionality implemented at the computing device 180 and/or the computing devices hosting the other sources 150.

In some embodiments, the features and functionality may include operations such as: obtaining training data (e.g., annotating content items from a first plurality of users, training records of the first plurality of users, the training records annotated with the training annotating content items, and/or the profile information and/or contextual information associated with the first plurality of users); training a record annotation machine learning model with the training data; receiving an annotating content item associated with a user of a second plurality of users; and utilizing the trained record machine learning model to: generate at least one derived annotating content item based at least in part on the annotating content item and data of the at least one first record; identify at least one second record related to the user of the second plurality of users based at least in part on: the data of the at least one first record and one or both of profile information and context information of the user of the second plurality of users; and annotate the at least one second record with the at least one derived annotating content item. In some embodiments not shown herein, the features and functionality of the server 101 may be partially or fully implemented at the computing device 180 such that the annotating process may be performed partially or entirely on the computing device 180 of the user.

In some embodiments, the application and data 108 may include an exemplary record annotation machine learning model 122. In some embodiments, the record annotation machine learning model 122 may be trained at the server 101. In other embodiments, the record annotation generation machine learning model 122 may be trained by another entity with the training data provided by the another entity, and/or with the training data provided by server 101. In some embodiments, the record annotation machine learning model 122 may also be trained and re-trained at the computing device 180 associated with the user. In the latter case, the record annotation machine learning model 122 may be trained and/or re-trained with training data specific to the user at the computing device 180. In this sense, the record annotation machine learning model 122 itself may be user-specific, residing on the server 101 and/or the computing device 180.

Various machine learning techniques may be applied to train and re-train the record annotation machine learning model 122 with training data and feedback data, respectively. In various implementations, such a machine learning process may be supervised, unsupervised, or a combination thereof. In some embodiments, such a machine learning model may comprise a statistical model, a mathematical model, a Bayesian dependency model, a naive Bayesian classifier, a Support Vector Machine (SVMs), a neural network(NN), and/or a Hidden Markov Model.

In some embodiments and, optionally, in combination of any embodiment described above or below, an exemplary neutral network technique may be one of, without limitation, feedforward neural network, radial basis function network, recurrent neural network, convolutional network (e.g., U-net) or other suitable network. In some embodiments and, optionally, in combination of any embodiment described above or below, an exemplary implementation of neural network may be executed as follows:

i) Define Neural Network architecture/model,

ii) Transfer the input data to the exemplary neural network model,

iii) Train the exemplary model incrementally,

iv) determine the accuracy for a specific number of timesteps,

v) apply the exemplary trained model to process the newly-received input data,

vi) optionally and in parallel, continue to train the exemplary trained model with a predetermined periodicity.

In some embodiments and, optionally, in combination of any embodiment described above or below, the exemplary record annotation machine learning model 122 may be in the form of a neural network, having at least a neural network topology, a series of activation functions, and connection weights. For example, the topology of a neural network may include a configuration of nodes of the neural network and connections between such nodes. In some embodiments and, optionally, in combination of any embodiment described above or below, the exemplary trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the exemplary aggregation function may be a mathematical function that combines (e.g., sum, product, etc.) input signals to the node. In some embodiments and, optionally, in combination of any embodiment described above or below, an output of the exemplary aggregation function may be used as input to the exemplary activation function. In some embodiments and, optionally, in combination of any embodiment described above or below, the bias may be a constant value or function that may be used by the aggregation function and/or the activation function to make the node more or less likely to be activated.

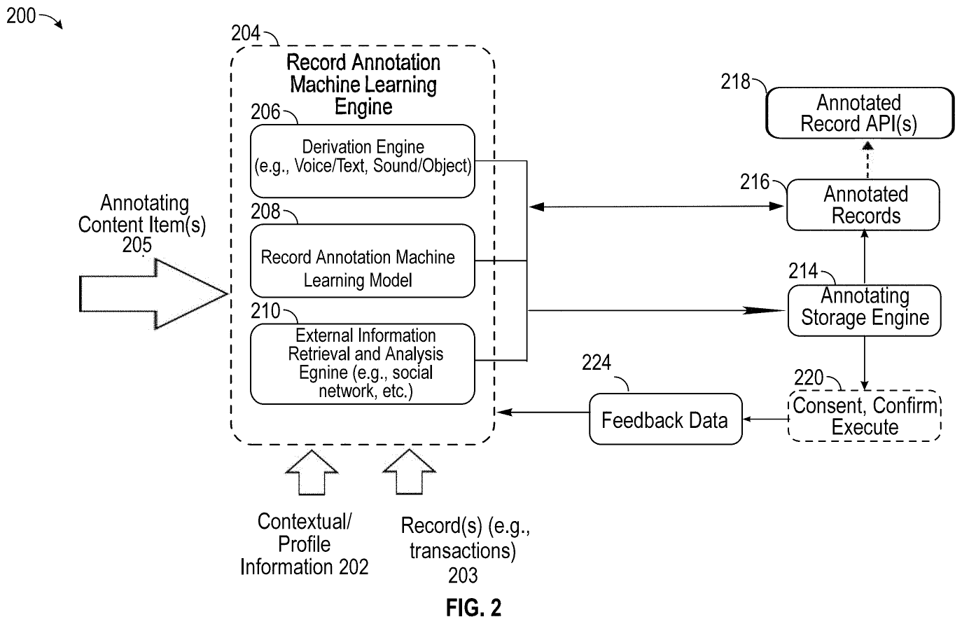

The application and data 108 may include a record annotating engine 124 that may be programmed to execute the record annotation machine learning model 122. In some embodiments, the record annotating engine 124 may receive, as input, the annotating data and utilize the record annotation machine learning model 122 to identify the respective to-be-annotated records. Subsequently, the record annotating engine 124 may associate and/or otherwise correlate the annotating data with the respective records and utilize the record annotation machine learning model 122 to generate annotated records. The annotated records may be stored in computer storage by utilizing any suitable technique(s). In one embodiment, the annotated records may be stored at the application and data 108 as well. More details of the record annotation machine learning model 122 and the record annotating engine 124 are described with reference to FIG. 2, below.

Still referring to FIG. 1, an illustrative computing device 180 associated with a user may comprise: one or more processors 181 and memory 182. Memory 182 may store instructions that, when executed by the one or more processors 181, perform various procedures, operations, or processes consistent with disclosed embodiments. In one embodiment, the memory 182 may include an application (APP) 194 that, when executed by the one or more processors 181, may perform operations such as generating annotating content 192, storing annotating content items, searching and/or retrieving annotating content 192, processing annotating content 192, transmitting to the server 101 annotating content 192/processed annotating content, interacting with (e.g., query, sort, rank, select, mark, display, modify with annotating data and/or records, delete annotating data and/or records, add with annotating data and/or records, etc.) annotated records via application 198 that implements, for example, a set of annotated record APIs, determining user's affirmation or other reactions with regard to annotated records, and training and re-training the record annotation machine learning model 122. In various embodiments, the application 198 may be implemented in any suitable manner such as, without limitation, a chat application, a browser extension, and the like.

In some embodiments, for the purpose of simplicity, features and functionalities associated with the exemplary record annotation machine learning model 122 (e.g., training, re-training, etc.) are illustrated as implemented by components of server 101. It should be noted that one more of those record annotation machine learning model-related aspects and/or features may be implemented at or in conjunction with the computing device 180 of the user. For example, in some embodiments, the machine learning model 122 may be partially trained at the server 101 with other users' records and annotating data, and in turn transmitted to the computing device 180 to be fully trained with the user specific user records and annotating data. In another example, the converse may be performed such that the machine learning model may be initially trained at the computing device 180 and subsequently transmitted to the server 101 for application and/or further training with training data from other users. Further, the annotating content 192 may also be stored entirely on the computing device 180, in conjunction with the server 101, or entirely at server 101.

While only one server 101, other sources 150, network 105, and computing device 180 are shown, it will be understood that system 100 may include more than one of any of these components. More generally, the components and arrangement of the components included in system 100 may vary. Thus, system 100 may include other components that perform or assist in the performance of one or more processes consistent with the disclosed embodiments. For instance, in some embodiments, the feature and functionality of the server 101 may be partially, or fully implemented at the computing device 180.

FIG. 2 is a diagram illustrating an exemplary record annotation architecture using machine learning techniques, consistent with exemplary aspects of certain embodiments of the present disclosure. In this illustrated embodiment, the exemplary record annotation architecture 200 may include an exemplary record annotation machine learning engine 204 utilized by an annotation engine 206 to generates a set of annotated records 216.

In some embodiments and as illustrated in FIG. 2, the record annotation machine learning engine 204 may be provided with two types of input data: annotating content item(s) 205 and record(s) 203 for annotation therewith. In some embodiments, record(s) 203 may include various transaction information such as, but not limited to, a time of a transaction, a merchant name of the transaction, an amount of charge, and the like. Such transaction information may be available to a banking system that processes charges incurred by customers. For instance, transaction information for a given transaction may be received at the time a charge is posted and/or authorized (e.g., when a credit card is swiped, a digital card is scanned for payment at a restaurant, when an on-line payment is made to purchase a product/service, etc.).

The annotating content item(s) 205 may be generated by the user, and/or crawled by a crawling component (e.g., an external information retrieval and analysis engine 210 of the record annotation machine learning engine 204) of the architecture 200 from other source(s). In some embodiments, the other source(s) can include the other source(s) 150 of FIG. 1. For instance, information including various content items may be searched/retrieved from social media websites, search platforms, websites, databases, and the like. In some embodiments, the annotating content item(s) 205 may include various types of information in various data formats. For example, the annotating content item(s) 205 may include photo(s), video(s), voice chat(s), as well as record(s) and/or respective annotating data associated therewith. In some embodiments, the annotating content item(s) 205 may be shared between users in the sense that one content item from a first user may be used to annotate a transaction of a second user.

In some embodiments, the record annotation machine learning engine 204 may further be provided with at least one of: user profile information or user contextual information 202. The profile information may comprise information relating to one or more of: demographic information, account information, application usage information, any data provided by the user, any data provided on behalf the user, and the like. The contextual aspect of the user profile information and user contextual information 202 may comprise information relating to one or more of: a timing, a location of the user, an action of a user, calendar information of the user, contact information of the user, habits of the user, preferences of the user, purchase history of the user, browsing history of the user, communication history, travel history, on-line payment service history, profile and/or contextual information of individual(s) and entity(ies) the user is associated with, and the like. In some embodiments, the user profile information and/or user contextual information 202 may be provided by the user, determined by the architecture 200, and/or a component external thereto, or in a combination thereof.

In some embodiments and as shown in FIG. 2, the record annotation machine learning engine 204 may comprise an illustrative derivation engine 206, an illustrative record annotation machine learning model 208, and an illustrative external information retrieval and analysis engine 210.

The derivation engine 206 may be trained to extract and/or derive information from the received annotating content items 205. Various data processing techniques and algorithms may be utilized by the derivation engine 206. In some embodiments, the derivation engine 206 may be configured and trained to extract voice utterance and/or sound from a video clip and in turn perform speech recognition to transcribe the content of the voice utterance. In another example, the derivation engine 206 may be configured and trained to perform image recognition (e.g., object and facial recognition) on one or more frames of a video clip, a photo, a screen capture image, and the like to determine the identity of people, objects, sceneries, landmarks, and so on. In yet another example, the derivation engine 206 may be configured and trained to perform OCR on images to determine the textual content thereof (e.g., determine a time display in an image, etc.). In one example, the metadata information associated with the annotating content items may be used by the derivation engine 206 to extract and derive information (e.g., location metadata of a photo, etc.). In various embodiments, the derivation engine 206 may be trained to perform similar extraction and derivation based on records and/or user profile/contextual information. Taking a transaction record for example, the derivation engine 206 may be trained to identify the transaction date, the transacting party, the transaction amount, other related transactions, etc.

In some embodiments, the record annotation machine learning model 208 may be trained to identify which record(s) are to be associated with the received annotating content item 205. In some embodiments, by the time the annotating content items are received, the respective record is not available to the architecture 200. In this case, the record annotation machine learning model 208 may be trained to store the annotating content item(s) in a manner indicating that corresponding record(s) need to be identified in the future. In some embodiments, the record annotation machine learning model 208 may be trained to configure a trigger to retrieve the corresponding transaction based on the received annotating content items and/or derived data. For example, the record annotation machine learning model 208 may be programmed to configure such a trigger based at least in part on information of the date, time, location, transaction party information gleaned from the annotating content and/or derived data. In some embodiments, the uploading of annotating content items to the architecture 200 does not have to be contemporaneous with the availability of the respective record. In some embodiments, by the time the annotating content item(s) would have been received, the respective record would be available to the architecture 200. In some embodiments, a record for annotation may be identified based on the user information of the user uploading the annotating content items from a collection of records indexed or otherwise associated with the user information.

In some embodiments, the record annotation machine learning model 208 may be trained to identify a record based on information of another record (annotated or not). For example, a first transaction of a user booking a round trip air ticket together with a hotel stay for a conference may be available to the architecture 200. After the user arrives at the destination city, the second transaction(s) made by the user at the destination city (e.g., meal purchase(s), souvenir purchase(s), etc.) may be identified based on the information associated with the first transaction, for example, the destination city information, the time duration of the conference, etc. In some embodiments, the record annotation machine learning model 208 may be trained to categorize the related second transaction(s) with the same category of the first transaction, for example, both being in a category of work related reimbursement. In some other embodiments, the record annotation machine learning model 208 may be trained to identify a record based on one or both of: profile information and/or context information of the user. Still using the example above, with the contextual information of the user indicating that, for example, the user is now at the destination city, there is a conference in town that is to be held in the next few days, the marked calendar entries of the user attending various sections of the conference, user's communication with others conveying the excitement expected at the conference, etc. As such, even if the first transaction only includes the transaction to purchase the conference ticket, the record annotation machine learning model 208 may be trained to identify the above described second transaction(s) as related to the first transaction.

The external information retrieval and analysis engine 210 may be trained to retrieve and/or analyze information as additional potential annotating content items for association with the identified record. In some embodiments, such retrieval may be performed automatically upon receiving one the annotating content item and/or identifying the record for annotation. In implementations, the external information retrieval and analysis engine 210 may utilize the derived data generated by the derivation engine 206 to perform such retrieval and/or analysis. For example, the external information retrieval and analysis engine 210 may be trained to automatically retrieve the menu and review information of a restaurant where the dinner depicted in an uploaded dinner photo took place, based on the derived data describing the restaurant (e.g., name, location, etc.). For another example, the external information retrieval and analysis engine 210 may be trained to use the derived transaction party information to automatically perform similar retrieval and analysis. In some embodiments, the analysis performed by the external information retrieval and analysis engine 210 may be substantially similar to the extraction and/or derivation functionality described for the derivation engine 206, and the details are not repeated herein.

In some embodiments, the record annotation machine learning engine 204 may be used by the annotating storage engine 214 to annotate various types of records. As illustrated here in this example, with the received annotating content items 205, the derived annotating data generated by the derivation engine 206, the identified record to be annotated, and/or additional annotating content items and data generated by the external information retrieval and analysis engine 210, the annotating storage engine 214 may associate all or a portion of the annotating content items/data with the identified record in any suitable manner. For example, the annotating storage engine 214 may store the annotating content items and the record in a database, and the like. The data storage for the annotated records may reside inside or outside of the architecture 200, and may be implemented via various data storage techniques (e.g., on a cloud, a distributed storage, etc.).

In this illustrated embodiment, the annotating storage engine 214 may store the annotated records 216 such that a user may access and interact with the annotated records via annotated record API(s) 218. In other embodiments, the annotated records 216 may also be accessed or interacted within one or more applications equipped with their respective manners to interface with the annotated records 216. In one example, the annotating content item in association with the corresponding record may be presented to the user at a first graphical user interface (GUI) of an application executing at a computing devices associated with the user. In various embodiments, such an application may be the application that the user utilizes to upload annotating content items, or any application (e.g., web browser) configured with access to the annotated records 216. In implementations, the presenting of the annotating content items may be configured in a variety of manners, such as, for example, a gallery type of display, a set of thumbnail tiles representing some or all of the annotating content items, banner display of textual annotating content, playback of a video and soundtrack, and the like.

In various embodiments, illustrative API(s) 218 may enable an accessing entity (e.g., users, other programs) to perform a variety of actions against the annotated records 216. By ways of non-limiting example, such actions may include a query request (e.g., search for a category of annotated records), a display request, a selection request, a sort/rank request, a filtering request with any criteria applicable, a modification request (e.g., add additional annotating items or records), a deletion request (delete an annotating content item or record), an action request (e.g., a reminder based on the annotated record), and the like. In some embodiments, the searched-for information may be matched in the annotated records 216. In one embodiment, the annotated records 216 may be categorized into a plurality of categories based on the annotating thereof. For example, the transactions related to meals/food/drinks may be categorized into business, personal, and the like. In one example, the above-described first GUI may be further configured with various user interface elements (e.g., text boxes, drop down lists, buttons, etc.) for the user to operate to perform these actions against the annotated records 216 at the first GUI. Accordingly, the user may, for example, query the annotated records for all the business lunches during the past month. In some embodiments, the relevant user profile information and current user contextual information may be used in connection with performing user's access requests to the annotated records. For instance, the user may send the annotated records 216 a request of “show me all the business lunches with my colleagues during the past three months.” In this example, the API(s) 218 may access the user profile and contextual information to determine who are the user's colleagues first.

For example, Bob may have left the company one month ago and the user met with Bob for lunch after his departure, the API(s) 218 may filter out the lunches with Bob after his departure when performing the user's request. In various embodiment, the contextual information that Bob is no longer a colleague of the user may be gathered in various manners, for example, user's emails, messages, farewell work party, etc.

In some embodiments, when the user queries the annotated records 216 with a question that further processing is required to find a potential answer, the record annotation machine learning engine 204 may also be utilized by the annotated records 216 to further derive information from the stored annotating content items via the derivation engine 206, and/or further retrieve and analyze pertinent/additional information from external sources via the external information retrieval and analysis engine 210. For example, for an uploaded dinner photo, if the record annotation machine learning engine 204 has not derived an answer that can match with the user's query (e.g., what is the brand of the beer ordered) against the already annotated record, the record annotation machine learning engine 204 may be used to further processing the photo and/or access external sources to determine the beer brand, which can be used to further annotate the already annotated record.

In this illustrated embodiment, the architecture 200 may further include a consent, confirm, and execute component 220. Here, the decision output from the record annotation machine learning engine 204 to associate an annotating content item with an identified record may be displayed or otherwise presented to the user for verification thereof. If the user approves the proposed annotating relationship, the annotating is performed by the annotating storage engine 214 and the annotated record is stored as part of the annotated records 216. In some embodiments, the user may also be presented with options to modify, add, delete the proposed annotating relationship, before the user consents to executing the annotating.

In this illustrated embodiment, the architecture 200 may further include a set of feedback data 224 for re-train the record annotation machine learning model 208 of the record annotation machine learning engine 204 with additional training data compiled from the user verified, user modified, user denied annotating decisions that comprise respective annotating content items, identified records, and/or user profile/contextual information.

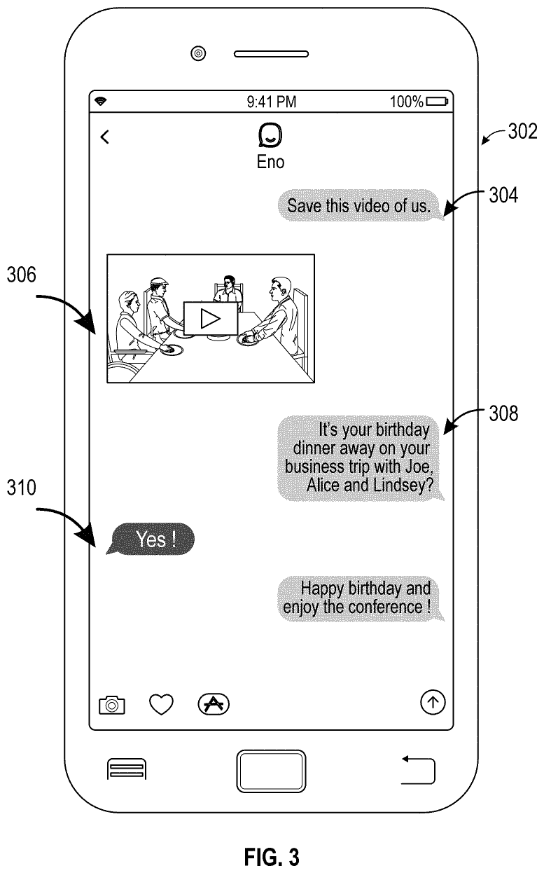

FIG. 3 is a diagram illustrating an exemplary graphical user interface (GUI) involving aspects and features associated with record annotation, consistent with exemplary aspects of certain embodiments of the present disclosure. In this example, a GUI 302 of a chat application (e.g., bot chat, etc.) is displayed at a screen of a mobile device associated with a user. It should be noted that various applications can be executed to enable the user at the mobile device to upload various annotating content to a server (e.g., the server 101 of FIG. 1) such that the server can in turn annotate various records therewith. For example, the applications can be implemented for the app 194 of FIG. 1; while the server can be implemented by the server 101 of FIG. 1.

As shown in FIG. 3, in some embodiments, without limitation, the user may utilize the chat application to communicate with a chat bot operated by a server (not shown), as a chat service. Here, the user may first send a text input of “Save this video of us” 304 to the chat bot, after which the user may send a video clip 306 to the chat bot. Upon receiving both the textual input and the video clip, the server may utilize a record annotation model (e.g., the record annotation machine learning model 208 of FIG. 2) to extract and/or derive annotating data from the video clip 306. Here in this example, the user would have registered for the chat service, the server may be configured or otherwise provided with various user profile information and/or user contextual information available via the chat service. For instance, the server may have access to the user profile that would have been generated upon the registration process. Such a profile may include information such as the user's full legal name, work address, home address, work phone number, home phone number, mobile phone number, email address, birthday, anniversary dates, and so on. As such, based on the user profile and the knowledge of today's date, the server may derive that today is the user's birthday. Various techniques may be deployed to equip the server with user profile information.

Further, the server may also be configured with various access to user contextual information. For example, in a prior chat session (not shown), the user may have used the chat bot to reserve air tickets and/or a hotel stay for a business trip out of town. In another example, the user may have sent to the server email receipts for the payment of the air tickets, hotel room, and conference ticket. In other words, the previous transaction and associated annotation content may be used as annotating content input (item(s)) for this dinner transaction. As such, given the details about the conference (e.g., the dates, the location, the flight status of the user's flights, etc.), the detected current location of the user, the current date, etc., the server may be able to derive that the user is on her business trip to a conference.

Further, as described above with reference to FIG. 2, the server may perform various image processing on the uploaded video clip to extract and derive annotating data therefrom. For example, the server may perform facial recognition on the video clip to determine that the user's colleagues, Joe, Alice, and Lindsey, are in the group dinner photo. In some embodiments, the server may cross check the dinner participants identity with other information available to the server. For example, the server may refer to the conference related information from Joe, Alice, and Lindsey to ensure that they indeed are attending the conference with the user. For another example, the server may use the detected current location of Joe, Alice, and Lindsey to ensure that they indeed travel to the conference and/or at about the same location where the user is currently at.

After determining the annotating data, the server may reply with a text of “It's your birthday dinner on your business trip with Joe, Alice, and Lindsey?” 308. The user may confirm with a text input of “Yes” 310 such that the server may proceed with annotating a transaction (related to the dinner) from the user with the video clip and/or the derived annotation data. In some embodiments, the indication to a transaction, as well as the input of the text 304 and the video clip 306 may be transmitted to the server in a contemporaneous manner from one or more computing devices of the user and/or merchant. That is, the user may notify the chat bot to save the video clip at a time that may be during the dinner, soon before the dinner, or soon after the dinner. In this case, the transaction may have not been posted to the user's account, and the server executing a record annotation machine learning model may be configured to store the annotating content and identify the respective transaction to annotate therewith at a late time. In some other embodiments, the user may send the video clip to the server at any point of time. For example, the user may send the chat bot the video clip after the trip to the conference when submitting her reimbursement requests for the conference trip. In this case, the server may be able to identify the respective transaction record for annotation without waiting for the transaction information to become available.

Once the user would have notified the server to store the video clip, a respective transaction (e.g., a transaction paying for the dinner depicted in the video clip) may be annotated with the video clip (and/or other derived annotating data) in a database of annotated records. Via, for example, the APIs described above with connection to FIG. 2, the server may enable the user to perform various interactions with the annotated record. Although not shown here in FIG. 2, using the same chat application or any other suitable applications (e.g., web browser, a banking app, etc.), the user may display the annotating content for the particular transaction, add another annotating content item to the same transaction, query the annotated records, submit requests, and the like. For example, the user may communicate the chat bot with questions and requests such as, “who was at my birthday dinner on the conference trip to Rome six months ago,” “remind me to buy them drinks at their birthdays,” “what is the brand of that beer Joe bought me,” and the like. In the scenario where a query cannot be matched with any annotating data stored, the server may be configured to further gather additional information, and/or process the annotating content associated with the transaction to glean further information to address the user's query. For instance, if the brand of the beer is not already captured in the annotating data for that birthday dinner, the server may perform further perform image analysis to recognize the items depicted in the video, crawl other sources at the Internet (e.g., reviews and menu on Yelp, posts regarding the same restaurant on social media sites, etc.), crawl other users' annotated records, etc. to determine the brand of the beer.

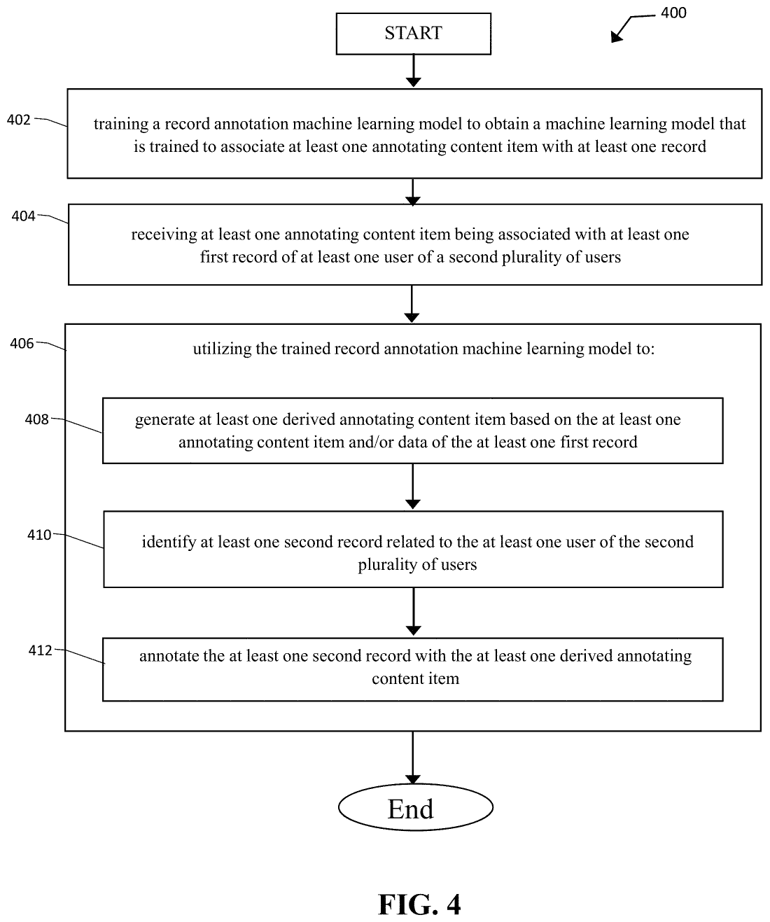

FIG. 4 is a flow diagram illustrating an exemplary process 400 related to record annotation via machine learning techniques, consistent with exemplary aspects of at least some embodiments of the present disclosure. Referring to FIG. 4, the illustrative record annotation process 400 may comprise: training a record annotation machine learning model to obtain a machine learning model that is trained to associate at least one annotating content item with at least one record, at 402; receiving at least one annotating content item being associated with at least one first record of at least one user of a second plurality of users, at 404; and utilizing the trained record annotation machine learning model, at 406, to: generate/predict at least one derived annotating content item based on the at least one annotating content item and/or data of the at least one first record, at 408; identify at least one second record related to the at least one user of the second plurality of users, at 410; and annotate the at least one second record with the at least one derived annotating content item, at 412. In other embodiments, the record annotation process 400 may be carried out, in whole or in part, in conjunction with a server, a transacting device, and/or a mobile device that is connected via one or more networks to the server, which is executing instructions for performing one or more steps or aspects of various embodiments described herein.

In some embodiments, the record annotation process 400 may include, at 402, a step of training a record annotation machine learning model to obtain a machine learning model that is trained to associate and/or predict an association of at least one annotating content item with at least one record. With regard to the disclosed innovation, the record annotation machine learning model may be trained based at least in part on one or more of: i) training annotating content items from a first plurality of users; ii) training records from the first plurality of users, the plurality of training records associated with the training annotating content items; and/or (iii) one or both of profile information and contextual information of the first plurality of users. In implementations, training annotating content items, training records, and/or profile information and contextual information may comprise information substantially similar to those described in the embodiments illustrated in connection with FIG. 2, and details are not repeated herein.

In some embodiments, the record annotation machine learning model may be trained via a server (e.g., the server 101 of FIG. 1), such as a processor of a computer platform, or an online computer platform. In some embodiments, the processor is associated with an entity that provides a financial service to the user. Here, for example, the at least one computer platform may comprise a financial service provider (FSP) system. This FSP system may comprise one or more servers and/or processors associated with a financial service entity that provides, maintains, manages, or otherwise offers financial services. Such financial service entity may include a bank, credit card issuer, or any other type of financial service entity that generates, provides, manages, and/or maintains financial service accounts for one or more customers. In other embodiments, the FSP system may outsource the training to a third-party model generator, or otherwise leverage the training annotating content items, the training records, training user profile/contextual information, and/or trained models from a third-party data source, third-party machine learning model generators, and the like.

It should be further understood that, in some embodiments, the record annotation machine learning model may be trained via a server in conjunction with a computing device of the user. Here, for example, the server may be configured to initially train a baseline record annotation model based on the above-described training data of the first plurality of users (not including a user of a second plurality of users) and/or a plurality of such training data from the plurality of third-party data sources. Subsequently, the baseline record annotation model may be transmitted to the computing device associated with the user of the second plurality of users to be trained with the particular training data of the user. In other words, a record annotation model may be trained in various manners and orders as a user-specific model in implementations.

The record annotation process 400 may include, at 404, a step of receiving at least one annotating content item being associated with at least one first record of at least one user of a second plurality of users. In some embodiments, the at least one annotating content item may comprise information associated with a record of the at least one user of the second plurality of users. In implementations, the at least one annotating content item may comprise information similar to those described in the embodiments illustrated in connection with FIG. 2, and details are not repeated herein.

In some embodiments, the step 404 may comprise automatically obtaining the at least one annotating content item from sources other than the at least one user of the second plurality of users. Details of automatically obtaining annotating content may be similar to those described with reference to FIGS. 2-3, and are not repeated herein.

The record annotation process 400 may include, at 406, a step of utilizing the trained record annotation machine learning model. At least some embodiments herein may be configured such that step 406 may include, at 408, a step to generate at least one derived annotating content item based on the at least one annotating content item and data of the at least one first record; at 410, a step to identify at least one second record related to the at least one user of the second plurality of users; and at 412, a step to annotate the at least one second record with the at least one derived annotating content item.

In some embodiments, the step 408 may comprise extracting the at least one derived annotating content item from the at least one annotating content item via at least one of: text recognition technique, voice recognition technique, or image recognition technique.

In some embodiments, the step 410 may comprise identifying at least one second record related to the at least one user of the second plurality of users based at least in part on one or more of: the data of the at least one first record, and/or one or both of profile information and context information of the at least one user of the second plurality of users.

In some embodiments, the record annotation process 400 may further include a step of presenting the at least one annotating content item in association with the at least one second record related to the at least one user of the second plurality of users at a first graphical user interface (GUI) of an application. In some embodiments, the application may be executing at a computing device associated with the at least one user of the second plurality of users.

In some embodiments, the record annotation process 400 may further include a step of obtaining at least one second annotating content item associated with the second record of the at least one user of the second plurality of users; and/or utilizing the record annotating machine learning model to annotate the second record based at least in part on the obtained at least one second annotating content item.

In some embodiments, the record annotation process 400 may further include a step of categorizing, by the one or more processors, a plurality of records of the at least one user of the second plurality of users based on the annotating of the plurality of records. In some embodiment, the step of categorizing may further comprise querying a plurality of records of the at least one user of the second plurality of users based on the categorizing of the plurality of records.

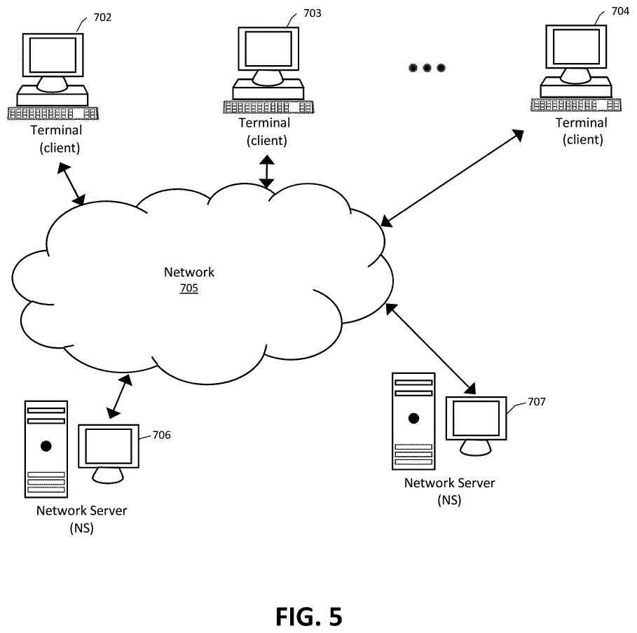

FIG. 5 depicts a block diagram of an exemplary computer-based system/platform in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the exemplary inventive computing devices and/or the exemplary inventive computing components of the exemplary computer-based system/platform may be configured to manage a large number of instances of software applications, users, and/or concurrent transactions, as detailed herein. In some embodiments, the exemplary computer-based system/platform may be based on a scalable computer and/or network architecture that incorporates varies strategies for assessing the data, caching, searching, and/or database connection pooling. An example of the scalable architecture is an architecture that is capable of operating multiple servers.

In some embodiments, referring to FIG. 5, members 702-704 (e.g., clients) of the exemplary computer-based system/platform may include virtually any computing device capable of receiving and sending a message over a network (e.g., cloud network), such as network 705, to and from another computing device, such as servers 706 and 707, each other, and the like. In some embodiments, the member devices 702-704 may be configured to implement part of the entirety of the features and functionalities above-described for the computing device 180 of FIG. 1. In some embodiments, the servers 706 and 707 may be configured to implement part of the entirety of the features and functionalities above-described for the server 101 of FIG. 1. In some embodiments, the member devices 702-704 may be personal computers, multiprocessor systems, microprocessor-based or programmable consumer electronics, network PCs, and the like. In some embodiments, one or more member devices within member devices 702-704 may include computing devices that typically connect using wireless communications media such as cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more member devices within member devices 702-704 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, one or more member devices within member devices 702-704 may include one or more applications, such as Internet browsers, mobile applications, voice calls, video games, videoconferencing, and email, among others. In some embodiments, one or more member devices within member devices 702-704 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 702-704 may be specifically programmed by either Java, .Net, QT, C, C++ and/or other suitable programming language. In some embodiments, one or more member devices within member devices 702-704 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 705 may provide network access, data transport and/or other services to any computing device coupled to it. In some embodiments, the exemplary network 705 may include and implement at least one specialized network architecture that may be based at least in part on one or more standards set by, for example, without limitation, GlobalSystem for Mobile communication (GSM) Association, the Internet Engineering Task Force (IETF), and the Worldwide Interoperability for Microwave Access (WiMAX) forum. In some embodiments, the exemplary network 705 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 705 may include and implement, as an alternative or in conjunction with one or more of the above, a WiMAX architecture defined by the WiMAX forum. In some embodiments and, optionally, in combination of any embodiment described above or below, the exemplary network 705 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 705 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 705 may also include mass storage, such as network attached storage (NAS), a storage area network (SAN), a content delivery network (CDN) or other forms of computer- or machine-readable media.

In some embodiments, the exemplary server 706 or the exemplary server 707 may be a web server (or a series of servers) running a network operating system, examples of which may include but are not limited to Microsoft Windows Server, Novell NetWare, or Linux. In some embodiments, the exemplary server 706 or the exemplary server 707 may be used for and/or provide cloud and/or network computing. Although not shown in FIG. 5, in some embodiments, the exemplary server 706 or the exemplary server 707 may have connections to external systems like email, SMS messaging, text messaging, ad content sources, etc. Any of the features of the exemplary server 706 may be also implemented in the exemplary server 707 and vice versa.

In some embodiments, one or more of the exemplary servers 706 and 707 may be specifically programmed to perform, in non-limiting example, as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing devices 701-704.

In some embodiments and, optionally, in combination of any embodiment described above or below, for example, one or more exemplary computing member devices 702-704, the exemplary server 706, and/or the exemplary server 707 may include a specifically programmed software module that may be configured to send, process, and receive information using a scripting language, a remote procedure call, an email, a tweet, Short Message Service (SMS), Multimedia Message Service (MMS), instant messaging (IM), internet relay chat (IRC), mIRC, Jabber, an application programming interface, Simple Object Access Protocol (SOAP) methods, Common Object Request Broker Architecture (CORBA), HTTP (Hypertext Transfer Protocol), REST (Representational State Transfer), or any combination thereof.

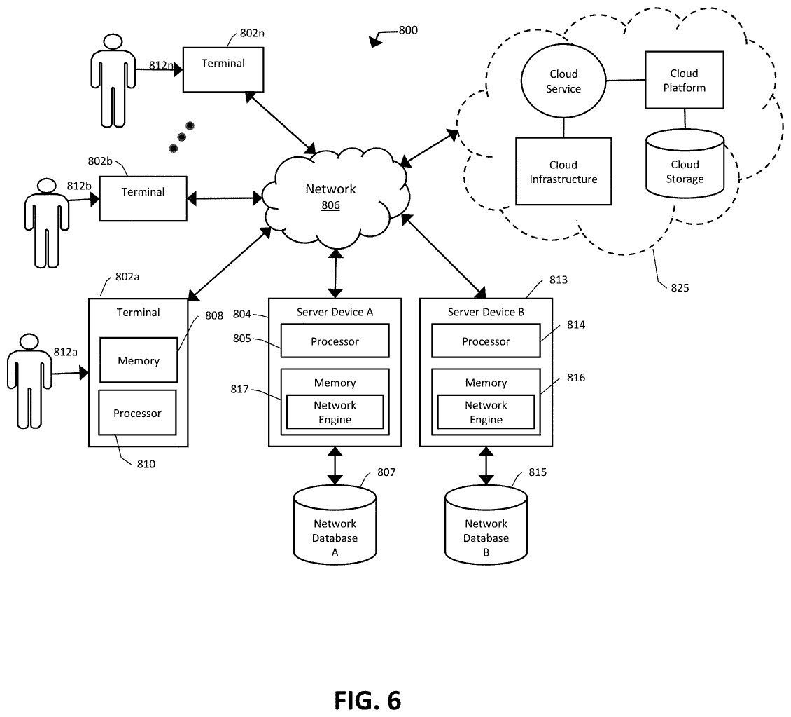

FIG. 6 depicts a block diagram of another exemplary computer-based system/platform 800 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing devices (e.g., clients) 802a, 802b through 802n shown each at least includes non-transitory computer-readable media, such as a random-access memory (RAM) 808 coupled to a processor 810 and/or memory 808. In some embodiments, the member computing devices 802a, 802b through 802n may be configured to implement part of the entirety of the features and functionalities above-described for the computing device 180 of FIG. 1. In some embodiments, the processor 810 may execute computer-executable program instructions stored in memory 808. In some embodiments, the processor 810 may include a microprocessor, an ASIC, and/or a state machine. In some embodiments, the processor 810 may include, or may be in communication with, media, for example computer-readable media, which stores instructions that, when executed by the processor 810, may cause the processor 810 to perform one or more steps described herein. In some embodiments, examples of computer-readable media may include, but are not limited to, an electronic, optical, magnetic, or other storage or transmission device capable of providing a processor, such as the processor 810 of client 802a, with computer-readable instructions. In some embodiments, other examples of suitable non-transitory media may include, but are not limited to, a floppy disk, CD-ROM, DVD, magnetic disk, memory chip, ROM, RAM, an ASIC, a configured processor, all optical media, all magnetic tape or other magnetic media, or any other media from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 802a through 802n may also comprise a number of external or internal devices such as a mouse, a CD-ROM, DVD, a physical or virtual keyboard, a display, a speaker, or other input or output devices. In some embodiments, examples of member computing devices 802a through 802n (e.g., clients) may be any type of processor-based platforms that are connected to a network 806 such as, without limitation, personal computers, digital assistants, personal digital assistants, smart phones, pagers, digital tablets, laptop computers, Internet appliances, and other processor-based devices. In some embodiments, member computing devices 802a through 802n may be specifically programmed with one or more application programs in accordance with one or more principles/methodologies detailed herein. In some embodiments, member computing devices 802a through 802n may operate on any operating system capable of supporting a browser or browser-enabled application, such as Microsoft™ Windows™, and/or Linux. In some embodiments, member computing devices 802a through 802n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 802a through 802n, users, 812a through 812n, may communicate over the exemplary network 806 with each other and/or with other systems and/or devices coupled to the network 806.

As shown in FIG. 6, exemplary server devices 804 and 813 may be also coupled to the network 806. In some embodiments, one or more member computing devices 802a through 802n may be mobile clients. In some embodiments, the server devices 804 and 813 may be configured to implement part of the entirety of the features and functionalities above-described for the server 101 of FIG. 1. In some embodiments, server devices 804 and 813 shown each at least includes respective computer-readable media, such as a random-access memory (RAM) coupled to a respective processor 805, 814 and/or respective memory 817, 816. In some embodiments, the processor 805, 814 may execute computer-executable program instructions stored in memory 817, 816, respectively. In some embodiments, the processor 805, 814 may include a microprocessor, an ASIC, and/or a state machine. In some embodiments, the processor 805, 814 may include, or may be in communication with, media, for example computer-readable media, which stores instructions that, when executed by the processor 805, 814, may cause the processor 805, 814 to perform one or more steps described herein. In some embodiments, examples of computer-readable media may include, but are not limited to, an electronic, optical, magnetic, or other storage or transmission device capable of providing a processor, such as the respective processor 805, 814 of server devices 804 and 813, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other media from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, at least one database of exemplary databases 807 and 815 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

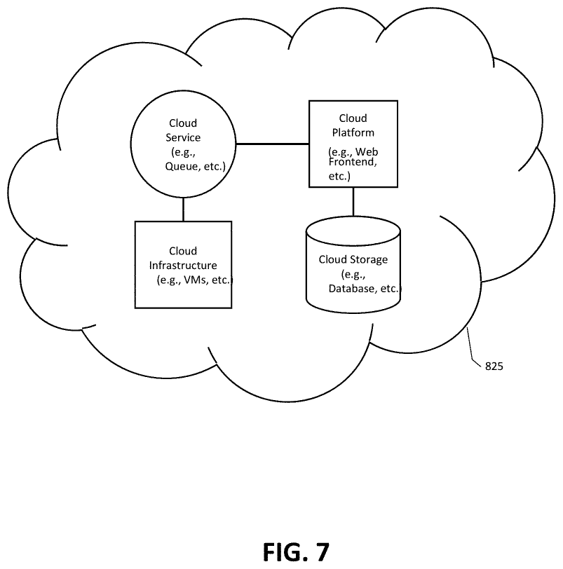

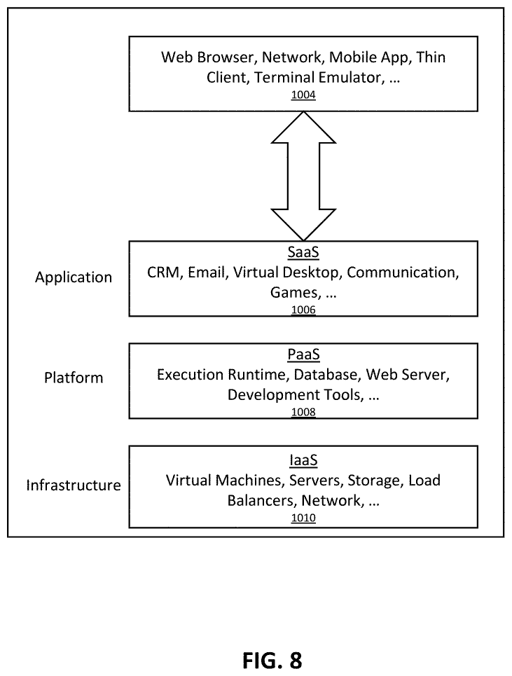

As also shown in FIGS. 7 and 8, some embodiments of the disclosed technology may also include and/or involve one or more cloud components 825, which are shown grouped together in the drawing for sake of illustration, though may be distributed in various ways as known in the art. Cloud components 825 may include one or more cloud services such as software applications (e.g., queue, etc.), one or more cloud platforms (e.g., a Web front-end, etc.), cloud infrastructure (e.g., virtual machines, etc.), and/or cloud storage (e.g., cloud databases, etc.).

According to some embodiments shown by way of one example in FIG. 8, the exemplary inventive computer-based systems/platforms, the exemplary inventive computer-based devices, components and media, and/or the exemplary inventive computer-implemented methods of the present disclosure may be specifically configured to operate in or with cloud computing/architecture such as, but not limiting to: infrastructure a service (IaaS) 1010, platform as a service (PaaS) 1008, and/or software as a service (SaaS) 1006. FIGS. 7 and 8 illustrate schematics of exemplary implementations of the cloud computing/architecture(s) in which the exemplary inventive computer-based systems/platforms, the exemplary inventive computer-implemented methods, and/or the exemplary inventive computer-based devices, components and/or media of the present disclosure may be specifically configured to operate. In some embodiments, such cloud architecture 1006, 1008, 1010 may be utilized in connection with the Web browser and browser extension aspects, shown at 1004, to achieve the innovations herein.

As used in the description and in any claims, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

In some embodiments, exemplary inventive, specially programmed computing systems/platforms with associated devices (e.g., the server 10, and/or the computing device 180 illustrated in FIG. 1) are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), Bluetooth™, near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes. Various embodiments herein may include interactive posters that involve wireless, e.g., Bluetooth™ and/or NFC, communication aspects, as set forth in more detail further below. In some embodiments, the NFC can represent a short-range wireless communications technology in which NFC-enabled devices are “swiped,” “bumped,” “tap” or otherwise moved in close proximity to communicate. In some embodiments, the NFC could include a set of short-range wireless technologies, typically requiring a distance of 10 cm or less. In some embodiments, the NFC may operate at 13.56 MHz on ISO/IEC 18000-3 air interface and at rates ranging from 106 kbit/s to 424 kbit/s. In some embodiments, the NFC can involve an initiator and a target; the initiator actively generates an RF field that can power a passive target. In some embodiments, this can enable NFC targets to take very simple form factors such as tags, stickers, key fobs, or cards that do not require batteries. In some embodiments, the NFC's peer-to-peer communication can be conducted when a plurality of NFC-enable devices (e.g., smartphones) are within close proximity of each other.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud components (e.g., FIG. 7-8) and cloud servers are examples.

In some embodiments, as detailed herein, one or more of exemplary inventive computer-based systems/platforms, exemplary inventive computer-based devices, and/or exemplary inventive computer-based components of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a social media post, a map, an entire application (e.g., a calculator), etc. In some embodiments, as detailed herein, one or more of exemplary inventive computer-based systems/platforms, exemplary inventive computer-based devices, and/or exemplary inventive computer-based components of the present disclosure may be implemented across one or more of various computer platforms such as, but not limited to: (1) FreeBSD™, NetBSD™, OpenBSD™; (2) Linux™; (3) Microsoft Windows™; (4) OS X (MacOS)™; (5) MacOS 11™; (6) Solaris™; (7) Android™; (8) iOS™; (9) Embedded Linux™; (10) Tizen™; (11) WebOS™; (12) IBM i™; (13) IBM AIX™; (14) Binary Runtime Environment for Wireless (BREW)™; (15) Cocoa (API)™; (16) Cocoa Touch™; (17) Java Platforms™; (18) JavaFX™; (19) JavaFX Mobile; ™(20) Microsoft DirectX™; (21) .NET Framework™; (22) Silverlight™; (23) Open Web Platform™; (24) Oracle Database™; (25) Qt™; (26) Eclipse Rich Client Platform™; (27) SAP NetWeaver™; (28) Smartface™; and/or (29) Windows Runtime™.

In some embodiments, exemplary inventive computer-based systems/platforms, exemplary inventive computer-based devices, and/or exemplary inventive computer-based components of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, exemplary inventive computer-based systems/platforms, exemplary inventive computer-based devices, and/or exemplary inventive computer-based components of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, and/or objects. For example, such projections may be a visual overlay for a mobile augmented reality (MAR) application.

In some embodiments, exemplary inventive computer-based systems/platforms, exemplary inventive computer-based devices, and/or exemplary inventive computer-based components of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, smart watch, or any other reasonable mobile electronic device.

As used herein, the terms “location data,” and “location information” refer to any form of location tracking technology or locating method that can be used to provide a location of, for example, a particular computing device/system/platform of the present disclosure and/or any associated computing devices, based at least in part on one or more of the following techniques/devices, without limitation: accelerometer(s), gyroscope(s), Global Positioning Systems (GPS); GPS accessed using Bluetooth™; GPS accessed using any reasonable form of wireless and/or non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, Cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed; this is in no way meant to be a limitation.

As used herein, the terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

The aforementioned examples are, of course, illustrative and not restrictive.

As used herein, the term “user” shall have a meaning of at least one user. In some embodiments, the terms “user”, “subscriber”, “consumer”, or “customer” should be understood to refer to a user of an application or applications as described herein and/or a consumer of data supplied by a data provider/source. By way of example, and not limitation, the terms “user” or “subscriber” can refer to a person who receives data provided by the data or service provider over the Internet in a browser session, or can refer to an automated software application which receives the data and stores or processes the data.

At least some aspects of the present disclosure will now be described with reference to the following numbered clauses.

What is claimed is:
Clause 1. A method comprising:
training, by one or more processors, a record annotation machine learning model to obtain a trained record annotation machine learning model that is trained to associate at least one annotating content item with at least one record, wherein the training is based at least in part on:

i) training annotating content items from a first plurality of users;

ii) a plurality of training records from the first plurality of users, the plurality of training records associated with the training annotating content items; and

iii) one or both of profile information and contextual information of the first plurality of users;
receiving, by the one or more processors, at least one annotating content item being associated with at least one first record of at least one user of a second plurality of users; utilizing, by the one or more processors, the trained record annotation machine learning model to: generate at least one derived annotating content item based at least in part on the at least one annotating content item and data of the at least one first record,
identify at least one second record related to the at least one user of the second plurality of users based at least in part on: the data of the at least one first record and one or both of profile information and context information of the at least one user of the second plurality of users, and annotate the at least one second record with the at least one derived annotating content item.
Clause 2. The method of clause 1 or any clause herein , further comprising: presenting, by the one or more processors, the at least one annotating content item in association with the at least one second record related to the at least one user of the second plurality of users at a first graphical user interface (GUI) of an application executing at a computing devices associated with the at least one user of the second plurality of users.
Clause 3. The method of clause 1 or any clause herein, further comprising: obtaining, by the one or more processors, at least one second annotating content item associated with the second record of the at least one user of the second plurality of users; and utilizing, by the one or more processors, the record annotating machine learning model to annotate the second record based at least in part on the obtained at least one second annotating content item.
Clause 4. The method of clause 1 or any clause herein, wherein the receiving of at least one annotating content item being associated with at least one first record of at least one user of a second plurality of users comprises:
automatically obtaining, by the one or more processors, the at least one annotating content item from sources other than the at least one user of the second plurality of users.
Clause 5. The method of clause 1 or any clause herein, further comprising: extracting, by the one or more processors, the at least one derived annotating content item from the at least one annotating content item via at least one of: text recognition technique, voice recognition technique, or image recognition technique.
Clause 6. The method of clause 1 or any clause herein, wherein the at least one annotating content item comprises information associated with a record of the at least one user of the second plurality of users.
Clause 7. The method of clause 1 or any clause herein, further comprising: categorizing, by the one or more processors, a plurality of records of the at least one user of the second plurality of users based on the annotating of the plurality of records.
Clause 8. The method of clause 1 or any clause herein, wherein the trained record annotation machine learning model is user-specific.
Clause 9. The method of clause 7 or any clause herein, further comprising:

querying, by the one or more processors, a plurality of records of the at least one user of the second plurality of users based on the categorizing of the plurality of records.
Clause 10. A system comprising:
one or more processors; and
a memory in communication with the one or more processors and storing instructions that, when executed by the one or more processors, cause the one or more processors to:
train a record annotation machine learning model to obtain a trained record annotation machine learning model that is trained to associate at least one annotating content item with at least one record, wherein the training is based at least in part on:
i) training annotating content items from a first plurality of users;
ii) a plurality of training records from the first plurality of users, the plurality of training records associated with the training annotating content items; and
iii) one or both of profile information and contextual information of the first plurality of users; receive at least one annotating content item being associated with at least one first record of at least one user of a second plurality of users;
utilize the trained record annotation machine learning model to:
generate at least one derived annotating content item based at least in part on the at least one annotating content item and data of the at least one first record,
identify at least one second record related to the at least one user of the second plurality of users based at least in part on: the data of the at least one first record and one or both of profile information and context information of the at least one user of the second plurality of users, and annotate the at least one second record with the at least one derived annotating content item.
Clause 11. The system of clause 10 or any clause herein, wherein the instructions further cause the one or more processors to presenting the at least one annotating content item in association with the at least one second record related to the at least one user of the second plurality of users at a first graphical user interface (GUI) of an application executing at a computing devices associated with the at least one user of the second plurality of users.
Clause 12. The system of clause 10 or any clause herein, wherein the instructions further cause the one or more processors to:
obtain at least one second annotating content item associated with the second record of the at least one user of the second plurality of users; and
utilize the record annotating machine learning model to annotate the second record based at least in part on the obtained at least one second annotating content item.
Clause 13. The system of clause 10 or any clause herein, wherein to receive at least one annotating content item being associated with at least one first record comprises to: automatically obtain the at least one annotating content item from sources other than the at least one user of the second plurality of users.
Clause 14. The system of clause 10 or any clause herein, wherein the instructions further cause the one or more processors to:
extract the at least one derived annotating content item from the at least one annotating content item via at least one of: text recognition technique, voice recognition technique, or image recognition technique.
Clause 15. The system of clause 10 or any clause herein, wherein the at least one annotating content item comprises information associated with a record of the at least one user of the second plurality of users.
Clause 16. The system of clause 10 or any clause herein, wherein the instructions further cause the one or more processors to categorize a plurality of records of the at least one user of the second plurality of users based on the annotating of the plurality of records.
Clause 17. The system of clause 10 or any clause herein, wherein the trained record annotation machine learning model is user-specific.
Clause 18. The system of clause 17 or any clause herein, wherein the instructions further cause the one or more processors to querying, by the one or more processors, a plurality of records of the at least one user of the second plurality of users based on the categorizing of the plurality of records.
Clause 19. A non-transitory computer readable storage medium for tangibly storing computer program instructions capable of being executed by a computer processor, the computer program instructions defining the steps of:
training a record annotation machine learning model to obtain a trained record annotation machine learning model that is trained to associate at least one annotating content item with at least one record, wherein the training is based at least in part on:

i) training annotating content items from a first plurality of users;

ii) a plurality of training records from the first plurality of users, the plurality of training records associated with the training annotating content items; and
iii) one or both of profile information and contextual information of the first plurality of users; receiving at least one annotating content item being associated with at least one first record of at least one user of a second plurality of users; utilizing the trained record annotation machine learning model to: generate at least one derived annotating content item based at least in part on the at least one annotating content item and data of the at least one first record, identify at least one second record related to the at least one user of the second plurality of users based at least in part on: the data of the at least one first record and one or both of profile information and context information of the at least one user of the second plurality of users, and annotate the at least one second record with the at least one derived annotating content item.
Clause 20. The computer readable storage medium of clause 19 or any clause herein, the steps further comprising presenting the at least one annotating content item in association with the at least one second record related to the at least one user of the second plurality of users at a first graphical user interface (GUI) of an application executing at a computing devices associated with the at least one user of the second plurality of users.

While one or more embodiments of the present disclosure have been described, it is understood that these embodiments are illustrative only, and not restrictive, and that many modifications may become apparent to those of ordinary skill in the art, including that various embodiments of the inventive methodologies, the inventive systems/platforms, and the inventive devices described herein can be utilized in any combination with each other. Further still, the various steps may be carried out in any desired order (and any desired steps may be added and/or any desired steps may be eliminated).

What is claimed is:

1. A method comprising:
training, by one or more processors, a record annotation machine learning model to obtain a trained record annotation machine learning model that is trained to associate at least one annotating content item with at least one record, wherein the training is based at least in part on:
i) training annotating content items from a first plurality of users;
ii) a plurality of training records from the first plurality of users, the plurality of training records associated with the training annotating content items; and
iii) one or both of profile information and contextual information of the first plurality of users;
receiving, by the one or more processors, at least one annotating content item being associated with at least one first record of at least one user of a second plurality of users; and
utilizing, by the one or more processors, the trained record annotation machine learning model to:
generate at least one derived annotating content item based at least in part on the at least one annotating content item and data of the at least one first record,
identify at least one second record related to the at least one user of the second plurality of users based at least in part on: the data of the at least one first record and one or both of profile information and context information of the at least one user of the second plurality of users, and annotate the at least one second record with the at least one derived annotating content item.

2. The method of claim 1, further comprising:
presenting, by the one or more processors, the at least one annotating content item in association with the at least one second record related to the at least one user of the second plurality of users at a first graphical user interface (GUI) of an application executing at a computing devices associated with the at least one user of the second plurality of users.

3. The method of claim 1, further comprising:
obtaining, by the one or more processors, at least one second annotating content item associated with the second record of the at least one user of the second plurality of users; and
utilizing, by the one or more processors, the record annotating machine learning model to annotate the second record based at least in part on the obtained at least one second annotating content item.

4. The method of claim 1, wherein the receiving of at least one annotating content item being associated with at least one first record of at least one user of a second plurality of users comprises:
automatically obtaining, by the one or more processors, the at least one annotating content item from sources other than the at least one user of the second plurality of users.

5. The method of claim 1, further comprising:
extracting, by the one or more processors, the at least one derived annotating content item from the at least one annotating content item via at least one of: text recognition technique, voice recognition technique, or image recognition technique.

6. The method of claim 1, wherein the at least one annotating content item comprises information associated with a record of the at least one user of the second plurality of users.

7. The method of claim 1, further comprising:
categorizing, by the one or more processors, a plurality of records of the at least one user of the second plurality of users based on the annotating of the plurality of records.

8. The method of claim 1, wherein the trained record annotation machine learning model is user-specific.

9. The method of claim 7, further comprising:
querying, by the one or more processors, a plurality of records of the at least one user of the second plurality of users based on the categorizing of the plurality of records.

10. A system comprising:
one or more processors; and
a memory in communication with the one or more processors and storing instructions that, when executed by the one or more processors, cause the one or more processors to:
train a record annotation machine learning model to obtain a trained record annotation machine learning model that is trained to associate at least one annotating content item with at least one record, wherein the training is based at least in part on:
i) training annotating content items from a first plurality of users;
ii) a plurality of training records from the first plurality of users, the plurality of training records associated with the training annotating content items; and
iii) one or both of profile information and contextual information of the first plurality of users;
receive at least one annotating content item being associated with at least one first record of at least one user of a second plurality of users; and
utilize the trained record annotation machine learning model to:
generate at least one derived annotating content item based at least in part on the at least one annotating content item and data of the at least one first record,
identify at least one second record related to the at least one user of the second plurality of users based at least in part on: the data of the at least one first record and one or both of profile information and context information of the at least one user of the second plurality of users, and
annotate the at least one second record with the at least one derived annotating content item.

11. The system of claim 10, wherein the instructions further cause the one or more processors to present the at least one annotating content item in association with the at least one second record related to the at least one user of the second plurality of users at a first graphical user interface (GUI) of an application executing at a computing devices associated with the at least one user of the second plurality of users.

12. The system of claim 10, wherein the instructions further cause the one or more processors to:
obtain at least one second annotating content item associated with the second record of the at least one user of the second plurality of users; and
utilize the record annotating machine learning model to annotate the second record based at least in part on the obtained at least one second annotating content item.

13. The system of claim 10, wherein the instructions further cause the one or more processors to:
automatically obtain the at least one annotating content item from sources other than the at least one user of the second plurality of users.

14. The system of claim 10, wherein the instructions further cause the one or more processors to:
extract the at least one derived annotating content item from the at least one annotating content item via at least one of: text recognition technique, voice recognition technique, or image recognition technique.

15. The system of claim 10, wherein the at least one annotating content item comprises information associated with a record of the at least one user of the second plurality of users.

16. The system of claim 10, wherein the instructions further cause the one or more processors to:
categorize a plurality of records of the at least one user of the second plurality of users based on the annotating of the plurality of records.

17. The system of claim 10, wherein the trained record annotation machine learning model is user-specific.

18. The system of claim 16, wherein the instructions further cause the one or more processors to:
query a plurality of records of the at least one user of the second plurality of users based on categorizing of the plurality of records.

19. A non-transitory computer readable storage medium for tangibly storing computer program instructions capable of being executed by a computer processor, the computer program instructions defining the steps of:
training a record annotation machine learning model to obtain a trained record annotation machine learning model that is trained to associate at least one annotating content item with at least one record, wherein the training is based at least in part on:
i) training annotating content items from a first plurality of users;
ii) a plurality of training records from the first plurality of users, the plurality of training records associated with the training annotating content items; and
iii) one or both of profile information and contextual information of the first plurality of users;
receiving at least one annotating content item being associated with at least one first record of at least one user of a second plurality of users; and
utilizing the trained record annotation machine learning model to:
generate at least one derived annotating content item based at least in part on the at least one annotating content item and data of the at least one first record,
identify at least one second record related to the at least one user of the second plurality of users based at least in part on: the data of the at least one first record and one or both of profile information and context
information of the at least one user of the second plurality of users, and annotate the at least one second record with the at least one derived annotating content item.

20. The computer readable storage medium of claim 19, the steps further comprising presenting the at least one annotating content item in association with the at least one second record related to the at least one user of the second plurality of users at a first graphical user interface (GUI) of an application executing at a computing devices associated with the at least one user of the second plurality of users.
